(19) United States
(12) Patent Application Publication
(10) Pub. No.: US 2026/0042076 A1
(43) Pub. Date: Feb. 12, 2026

(54) IN-SITU HOT FILTRATION FOR GAS-SOLID-SEPARATION IN CARBIDE-DERIVED CARBON PRODUCTION

(71) Applicant: Skeleton Technologies GmbH, GROßRÖHRSDORF (DE)

(72) Inventors: Ohannes Yeghia Ohannes MARKARIAN, GROßRÖHRSDORF (DE); Jaan LEIS, GROßRÖHRSDORF (DE); Sebastian WINZER, GROßRÖHRSDORF (DE)

(21) Appl. No.: 19/100,329

(22) PCT Filed: Jul. 28, 2023
(86) PCT No.: PCT/EP2023/070965

§ 371 Date: Jan. 31, 2025

(30) Foreign Application Priority Data
Aug. 3, 2022 (DE) 10 2022 119 516.3

(51) Int. Cl. B01J 8/00; B01D 39/20; B01D 46/24; B01D 46/58; B01J 8/18; B01J 8/24; C01B 32/05

(52) U.S. Cl. CPC B01J 8/006; B01D 39/2068; B01D 46/2407; B01D 46/58; B01J 8/1827; B01J 8/24; C01B 32/05; B01D 2273/20; B01J 2208/00761; B01J 2208/00938

(57) ABSTRACT

A reactor for producing a carbide-derived carbon by reacting a halogen gas with a metallic carbide material, the reactor comprising a reaction chamber and a filter arrangement configured for and discharging gas and having at least one filtration element that is configured for performing gas-solid separation. During operation of the reactor, the reaction chamber has a reaction zone with temperatures above 600° C., and the filtration element is configured to allow gas-solid separation within the reaction zone.

### CROSS-REFERENCES TO RELATED APPLICATIONS

This application is a national phase of International Patent Application No. PCT/EP2023/070965, filed on Jul. 28, 2023, which claims the benefit of German Patent Application No. 10 2022 119 516.3, filed on Aug. 3, 2022, the entire disclosures of which are incorporated herein by way of reference.

### FIELD OF THE INVENTION

The present invention is related to the advanced production process of microporous carbon. The herein described apparatus and method is related to the in-situ hot filtration for gas solid separation within the heated zone of the reactor, associated with the manufacturing of porous carbon and metal halides from metal carbides. In more details, the described apparatus and method herein relates to processes and equipment for a batch, semi-batch, or continuous gas solid separation process within the heated zone of the reactor, resulting from the halogenation of metal carbides to form porous carbon and metal halide, by means of direct filtration.

### BACKGROUND OF THE INVENTION

Porous carbon materials are found to be used in applications ranging from energy storage over filtering and adsorption processes. Especially in energy storage as well as in filtering applications, the high specific surface area of this class of material is of interest. Carbide-derived carbons (CDCs) represent a class of high-surface area microporous carbons with narrow poresize distribution and high surface-to-volume ratio. Commonly, the CDCs are manufactured by chemically stripping metal- or metalloid carbides from their metal or metalloid contents by halogenation at high temperatures, for example in the range of 200° C. to 1200° C. as a temperature of reaction zone, leaving metal- or metalloid chlorides and the microporous carbon as the product.

CDCs can be synthesized from many different precursors hereinafter referred to as carbides: binary carbides (such as TIC, SiC, Al₄C₃, Mo₂C, SiC, B₄C, ZrC, NbC, etc.)., or similar compounds with oxygen (such as oxycarbides, MCₓO_{y}) or nitrogen (such as carbonitrides, MCₓN_{y}), or tertiary carbides (such as M1ₓM2_{y}C), or the mixtures of those. Commonly, the precursor is in the form of powder with variable particle size distributions, but also the agglomerates or pellets or film of carbide can be used. From the point of view of structural order, the precursor carbide may be monolithic crystal or polycrystalline or porous biomorphic carbide or of any other morphology.

There are several methods to extract the non-carbon atoms from carbide, the most widespread is a chemical extraction with halogen gas (X₂) at high temperature (Eq. (1)):

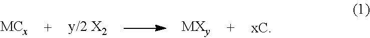

Gas-solid reactors, such as stationary bed, rotational kiln, or fluidized bed reactors can be used to react raw material (reactants), carbide and halogen gas. A mixture of reactants and products is found in the heated reaction zone. In principle, the solids (solid bed, fluidized bed) stay within the reaction zone (or within the reactor) and the gas flow (the halogen(s)) enters as reactant(s) and leaves as a mixture of metal halides and halogen(s).

US 2012/219 488 A1 discloses a typical stationary bed reactor apparatus for continuous manufacturing of porous carbon material by halogenation of carbides.

A typical reaction type uses chlorine gas (Cl₂). According to the mass-balance of chlorination reaction (see Eq. (1)), the theoretical yield of carbide-derived carbon (CDC) from different carbides may range from ˜6 wt % in the case of molybdenum carbide to almost 30 wt % for silicon carbide. In fact, the main product of carbide chlorination reaction is a chloride of the respective carbide-forming metal or metalloid (MCl_{y}) as shown in TABLE 1. Therefore, the reactor for efficient manufacturing of porous carbon by halogenation of metal carbides at elevated temperatures must be designed in the way to provide the maximum separation of both products, CDC and metal chloride, while maintaining the homogeneous temperature conditions in the heated reaction zone.

TABLE 1
Relative weight-distribution of products (CDC and Mcly)
for different carbides by chlorination treatment.

| Carbide | | | |
|---|---|---|---|
| (MCₓ) | Reaction | CDC, % | MCl_{y}, % |
| SiC | SiC + 2 Cl₂ → SiCl₄ + C | 6.6 | 93.4 |
| TiC | TiC + 2 Cl₂ → TiCl₄ + C | 5.9 | 94.1 |
| Mo₂C | Mo₂C + 5 Cl₂ → 2 MoCl₅ + C | 4.2 | 95.8 |
| Al₄C₃ | Al₄C₃ + 6 Cl₂ → 4 AlCl₃ + 3 C | 4.0 | 96.0 |
| B₄C | B₄C + 6 Cl₂ → 4 BiCl₃ + C | 6.0 | 94.0 |
| ZrC | ZrC + 2 Cl₂ → ZrCl₄ + C | 4.9 | 95.1 |
| NbC | 2 NbC + 5 Cl₂ → 2 NbCl₅ + 2 C | 4.2 | 95.8 |
| HfC | HfC + 2 Cl₂ → HfCl₄ + C | 3.6 | 96.4 |

CDC recovery rate is relevant for the overall yield of the process, while at the same time a gas flow of metal halides and halogen(s) leaving the reactor needs to be cleared of all solid components (in this case the CDC and/or partially reacted carbide and/or pure carbides), having any solids within the gas flow will lead to complications in downflow units (such as condensers, filters, pumps, etc.) and complications within the further processing on the metal halides and halogen(s). It is also relevant to keep uniform conditions for the solids, meaning that changes and/or fluctuations within the temperature of solids usually result in a non-uniform characteristic of the produced CDC, which should be avoided. In addition, the solids (partially or fully converted CDC) should be kept from getting into contact with any surface/material that can be a source of contaminants and/or provide possible catalytic capabilities for graphitization of CDC.

Gas-solid reactors typically include gas/solid separation units, such as cyclones and/or filters. Cyclones are limited as gas/solid separators in the particle size range of above 20 μm, with the efficiency getting lower with smaller particle sizes. The USEPA reports the follow efficiencies in document (EPA-452/F-03-005):

TABLE 2
Cyclone type vs. removal efficiency
(%) for particulate matter (PM)

| | PM for >10 | PM for 10 | PM for 2.5 |
|---|---|---|---|
| Cyclone type | μm particles | μm particles | μm particles |
| Conventional Cyclone | 70-90 | 30-90 | 0-40 |
| High Efficiency Cyclone | 80-99 | 60-95 | 20-70 |
| High Throughput Cyclone | 80-90 | 10-40 | 80-95 |

Thus, particles within the range of 10 μm or below will most likely not be separated.

U.S. Pat. No. 6,673,133 B2 shows difficulties of separation of particles below 50 μm in FCC units that results in FCC catalyst concentrations of 200-1000 mg/Nm³.

Noting here that even though a PSD (particle size distribution) can be measured for the raw material, metal- or metalloid carbide, to be used for CDC production, this does not mean that the resulting CDC would have the exact same PSD as particles are subject to attrition. This is caused by the mechanical stress that the particles are subjected to due to interparticle collisions and/or solids bed to wall impacts, which in turn leads to gradual degradation of the particles (abrasion).

The exothermic nature of the reaction of CDC production is also a contributing factor and adds thermal stress, which can, at discrete times, be localized and cause fractures in the structure (fragmentation).

The use of gas-solid separation methods such as cyclones and/or filters at a different stage of CDC production, which require a change in the flow properties (such as the temperature), is of low efficiency and exposes the material to different conditions, which impact the characteristics, thus the performance of the CDC eventually. Having the material leave the reaction zone or the reactor itself and coming into contact with other unit operations or other materials of construction also exposes the fully or partially reacted CDC to contaminants, which in turn impact the performance of the material when returned into the reactor and recovered as a product. Low gas-solid separation efficiency also introduces a risk of accumulation, formation of sludges with condensed metal halides, and clogging of unit operations, equipment, and pipes which can have severe safety impacts.

Gaseous flows associated with CDC production are composed of metal halides (e.g. metal chlorides) and halogen(s) gas (e.g. chlorine) or its hydrogen derivatives (e.g. hydrogen chloride).

Due to CDC production reaction conditions, gaseous flow leaves reactor at elevated temperature of over 600° C. Metal chlorides are known to cause high corrosion rates of metal alloys, which therefore require the use of specialty materials as material of construction for the condenser. Corrosion of metal alloys introduces undesired contaminants to gaseous flow. Even specialty materials can introduce contaminants at elevated temperatures. This also means that any partially or fully reacted CDC comes into contact with different materials of construction at location other than the reactor itself, will be returned to the reactor or heated zone with possible contaminants formed due to the high temperature and corrosiveness of the metal halides and halogen(s). These contaminants can in turn impact the purity of CDC produced and/or the characteristics, eventually impacting performance.

Typical construction material, 316L stainless steel, which can be used for the cyclones, has a recommended upper limit of operation with dry chlorine contact, as per (Special Metals Corporation) publication (SMC-026), of 343° C.

### SUMMARY OF THE INVENTION

It is an object of the invention to improve the efficiency of the CDC production process.

The object may be achieved by the subject-matter of one or more embodiments described herein.

The invention provides a reactor for producing a carbide-derived carbon by reacting a halogen gas with a metallic carbide material, the reactor comprising a reaction chamber and a filter arrangement that is configured for and discharging gas and having at least one filtration element that is configured for performing gas-solid separation, wherein, when in operation, the reaction chamber has a reaction zone with temperatures above 600° C., and the filtration element is configured so as to allow gas-solid separation within the reaction zone.

Preferably, the reactor is configured as a fluidized bed reactor and comprises a plenum and a gas distribution plate separating the reaction chamber from the plenum, wherein, when in operation, the reaction zone is formed adjacent to the gas distribution plate.

Preferably, the reaction chamber has a chamber top and, when in operation, a non-reaction zone with temperatures below 600° C. is formed adjacent to the reaction zone, and the filtration element extends from the chamber top through the non-reaction zone towards the reaction zone.

Preferably, the filtration element extends into the reaction zone. Preferably, the filtration element extends such that, when in operation, the filtration element extends into fluidized material.

Preferably, the filtration element has a filtration wall that defines a gas channel, and the gas channel is separated from the reaction chamber by the filtration wall.

Preferably, the filtration element is made of macroporous material, preferably macroporous ceramic carbon material, wherein the pore diameter is configured to reduce the amount of partially or fully converted carbide-derived carbon escaping from the reaction chamber.

Preferably, the filter arrangement comprises a first filtration element and a second filtration element that are fluidly connected so as to combine a gas flow from each of the first filtration element and the second filtration element into a single exhaust flow.

The invention provides a method for producing carbide-derived carbon by reacting a halogen gas with a metallic carbide material within a reactor, preferably a reactor according to any of the preceding claims, having a reaction chamber, wherein, during the reaction of halogen gas with the carbide material, gas-solid separation is performed by a filtration element of a filter arrangement within a reaction zone of the reaction chamber, and the reaction zone has a temperature above 600° C.

Preferably, the reactor is configured as a fluidized bed reactor and comprises a plenum and a gas distribution plate separating the reaction chamber from the plenum, wherein, during operation, the reaction zone is formed adjacent to the gas distribution plate.

Preferably, the reaction chamber has a chamber top and, during operation, a non-reaction zone with temperatures below 600° C. is formed adjacent to the reaction zone, and the filtration element performs gas-solid separation within the non-reaction zone and the reaction zone.

Preferably, during operation, the filtration element engages material fluidized by the gas flowing from the plenum to the reaction chamber.

Preferably, the filtration element performs gas-solid separation with a filtration wall and discharges the filtered gas through a gas channel.

Preferably, the filter arrangement includes a plurality of filtration elements, and the filter arrangement combines a gas flow from each of the filtration elements into a single exhaust flow.

The invention provides using a filtration element made of porous material for gas-solid separation in contact with a reaction zone with temperatures of at least 600° C. and optionally in contact with a corrosive environment, such as a halogen gas.

The invention provides a method for in-situ hot filtration for gas-solid separation within the heated zone of a fluidized bed reactor of the carbon production from metal- or metalloid carbide or the mixture of such carbides using extraction of non-carbon atoms from the metal- or metalloid carbide by reacting the carbide with halogen containing gas at high temperatures.

The method described in this document comprises in-situ gas-solid separation within the heated zone of the reactor, while keeping gas flow leaving the reactor free of any solid particles. Reducing any parametric fluctuation exposure to the partially of fully converted CDC and any exposure to surfaces/materials of construction that may introduce impurities within the solids bed.

With this it is possible to have higher flowrates of gas flow, contributing to the reduced overall time requirements of the batch in progress. This is possible due to the different separation method used for the gas-solid separation, compared to other methods, such as cyclones.

Thermal shock, material compatibility, and filter capabilities such as low pressure drop requirements and buildup & support of permeable filter cake are considered. Any and all material in contact with the solids (partially or fully converted CDC) is made of material that does not introduce contaminants or acts as a graphitization catalyst when in contact with the solids. Material of construction selection is also based on the capability of withstanding process conditions without or with minimal degradation.

Preferably, a method for producing of carbide-derived carbon via reacting a metal- or metalloid carbide with a halogen gas, comprises a reaction chamber equipped with an inlet for reagent gas flow, a filter arrangement that is in a hot zone, and an outlet for the leaving gas flow. Preferably, a high-efficiency gas-solid separation is integrated within the reaction chamber at high temperatures above 600° C. and a corrosive environment.

Preferably, the halogen gas is chlorine and the temperature of reaction unit is in the range of 600-1200° C.

Preferably, the gas-solid separation reduces or minimizes the losses of partially or fully converted carbide-derived carbon from the reactor that increases the overall yield of CDC.

Preferably, the contact between partially and/or fully converted CDC with contaminating surfaces is reduced or eliminated.

Preferably, exposure of a uniform parametric profile, such as temperature, is maintained for the partially and/or fully converted CDC.

Preferably, the solid components are reduced or eliminated within the leaving gas flow.

Preferably, gas-solid separation causes reduction in overall batch cycle and/or conversion time via increased halogen(s) flow rates into the reactor.

Preferably, a fluidized bed reactor comprises a reactor chamber, a gas inlet for reactive and/or inert gas. Preferably, at least two filtering elements are arranged in a reactor zone having temperatures above 600° C. Preferably, the filtering element comprises a filtered gas flow outlet, where filtered gas flow from a first filtering element is combined with a filtered gas flow from a second filtering element, which in turn proceeds to downflow units.

Preferably, the filter elements are at least partially located within the heated zone at any arrangements and/or at any height within the zone, even submerged into the solids bed.

In one example, silicon carbide, SiC, is used for the synthesis of CDC according to the general reaction presented in Table 1, the reaction takes place at about 900-1200° C., depending on requirements, heating profile of reactor, and length of heated zone. In the case of SiC chlorination, a composition of the gaseous flow is mostly silicon tetrachloride (SiCl₄, STC) and unreacted chlorine gas (Cl₂). In addition to these main components, it is noted that this gaseous flow may contain an unknown amount of hydrochloric acid (HCl) due to some moisture within the chlorine gas flow (99.8% purity), which in turn turns into HCl within the system. In addition to, any inert gas(es) used for reaction kinetics control, energy release control, fluidization control, and inertization and/or heating/cooling of process equipment also leave with the gas flow at different quantities depending on stage of process.

The present ideas enable improvements in CDC production technology. It should be noted that not all advantages must be present at the same time or with the same intensity. Advantages include, but are not limited to:
higher efficiency gas/solid separation of over 90% operational within the heated zone in reactor;
a gas/solid separation method capable of operating within process condition of over 600° C. and halogen(s) presence;
significant reduction of solids within the gas flow leaving the reaction zone/reactor;
maintaining uniform exposure of solids (partially or fully converted CDC) to process conditions, such as temperature, eliminating parametric fluctuations on solids;
reducing contact between solids (partially or fully converted CDC) with surfaces/materials of construction that can introduce contaminants or act as graphitization catalysts to CDC;
reducing any impact of abrasion caused by solids on surfaces;
introducing the option of increased raw gas flow flowrates of halogen(s), resulting in reduced overall batch cycles;
reduced maintenance and cleanup effort of downflow equipment/units due to the reduction of solids entrained with gas flow flowing out from the reactor;
lower corrosion rates induced by solids contacting downflow equipment/units.

One idea of this invention is to improve the purity of both solids and gas flow by reducing the chance of contact between any solids leaving the heated zone or reactor with other materials. Another idea comprises the reduction of solids leaving with the gas flow, which otherwise would contaminate the gas flow with solids (partially or fully reacted CDC). Ideally a separation efficiency of above 90% is achieved. Due to a higher separation efficiency and a different approach of gas/solid separation, higher overall flowrates of gas flow can be achieved, reducing the overall time requirements of carbide-to-CDC conversion.

The overall number of filtration elements can be chosen between two and ten filtration elements, wherein typically six filtration elements are used. It should be noted that even one filtration element shows some improvement over the conventional configurations. The arrangement of filter elements can be vertical, horizontal, and/or any other possible arrangements and/or combinations. Filter elements can be used in batch, and/or semibatch, and/or continuous form. Filter cleaning systems such as pulsing systems can be avoided with the ideas discloses herein. Filter elements are composed of material compatible with process requirements, do not introduce contaminants within the process, final product(s), or side product(s). An example for such material is carbon ceramic material that is manufactured from different carbon grain size fractions with the carbon grains integrally linked by carbon bridges.

### BRIEF DESCRIPTION OF THE DRAWINGS

The invention is described with reference to the accompanying schematic drawings Therein:

FIG. 1 depicts an embodiment of a reactor during operation; and

FIG. 2 depicts a variant of the reactor of FIG. 1.

### DETAILED DESCRIPTION OF THE PREFERRED EMBODIMENTS

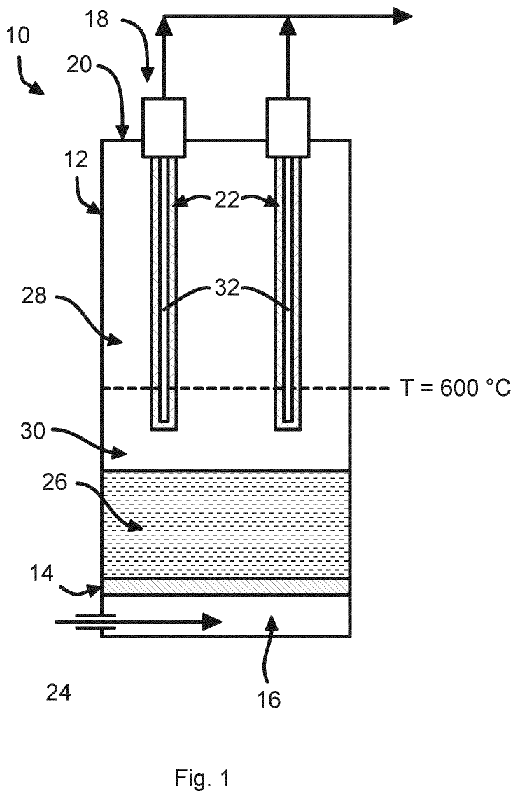

Referring to FIG. 1, a reactor 10 is preferably configured as a fluidized bed reactor. The reactor 10 comprises a reaction chamber 12, a gas distribution plate 14, and a plenum 16. The reactor 10 further comprises a filter arrangement 18 that is supported by the reaction chamber 12 at its chamber top 20. The filter arrangement 18 includes a plurality of filtration elements 22 that extend from the chamber top 20 towards the gas distribution plate 14.

During operation, particulate carbide material, e.g. SiC, is filled into the reaction chamber 12. A suitable halogen gas, e.g. Cl₂, is fed through an inlet 24 into the plenum 16 and distributed by the gas distribution plate 14 into the reaction chamber 12. The particulate carbide material is impinged by the halogen gas and forms a fluidized bed 26.

Due to the exothermic nature of the reaction and external heating, the solid material and gas(es) cause the reaction chamber 12 to form a non-reaction zone 28 and a reaction zone 30 that are separated by a temperature T=600° C. The reaction zone 30 has a temperature of at least 600° C., whereas the non-reaction zone 28 has temperatures below 600° C.

The filtration elements 22 extend into the reaction zone 30 and separate gas from solids. Each filtration element 22 has roughly a hollow cylinder shape and is closed off towards the bottom. Inside the filtration element 22 there is a gas channel 32 that is open at the top and closed at the bottom. The gas escapes into the hollow filtration element 22 and is filtered. The gas then further escapes through the gas channel 32 and is fed to further processes downstream, such as cyclone and washer (both not shown). The gas flow from two filtration elements 22 is preferably combined into a single exhaust flow before feeding the exhaust flow downstream.

As a result, solid particles carried with the gas flow leaving the fluidized bed 26 are filtered out via in-situ hot filtration within the reaction zone 30.

Unlike most gas-solid separation units, the in-situ hot filtration for gas solid separation unit is capable of handling a wide range of particle size distributions 2.5 μm and more and degrees of conversion of solids from carbide to carbon (combined with the change in overall density and weight of particles).

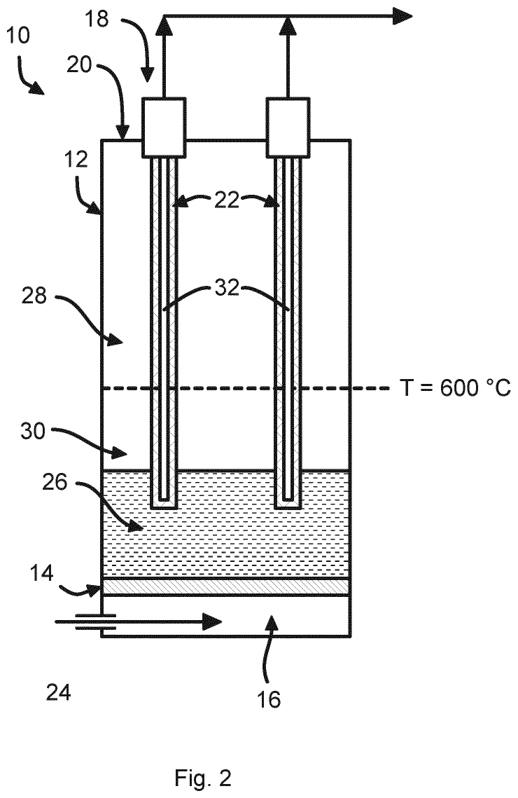

In a variant depicted in FIG. 2, the filtration elements 22 not only extend into the reaction zone 30, but also extend into the fluidized bed 26.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 reactor
12 reaction chamber
14 gas distribution plate
16 plenum
18 filter arrangement
20 chamber top
22 filtration element
24 inlet
26 fluidized bed
28 non-reaction zone
30 reaction zone
32 gas channel

1.-15. (canceled)

16. A reactor for producing a carbide-derived carbon by reacting a halogen gas with a metallic carbide material, the reactor comprising:
a reaction chamber, and
a filter arrangement configured for and discharging gas and having at least one filtration element configured for performing gas-solid separation,
wherein, when the reaction chamber has a reaction zone with a temperature above 600° C., the at least one filtration element is configured to allow gas-solid separation within the reaction zone.

17. The reactor according to claim 16, wherein the reactor is a fluidized bed reactor having a plenum and a gas distribution plate separating the reaction chamber from the plenum,
wherein, when in operation, the reaction zone is formed adjacent to the gas distribution plate.

18. The reactor according to claim 17, wherein the reaction chamber has a chamber top and, when in operation, a non-reaction zone with temperatures below 600° C. is formed adjacent to the reaction zone, and
wherein the at least one filtration element extends from the chamber top through the non-reaction zone towards the reaction zone.

19. The reactor according to claim 17, wherein, when in operation, the filtration element extends into fluidized material.

20. The reactor according to claim 16, wherein the at least one filtration element extends into the reaction zone.

21. The reactor according to claim 16, wherein the at least one filtration element has a filtration wall that defines a gas channel, and the gas channel is separated from the reaction chamber by the filtration wall.

22. The reactor according to claim 16, wherein the at least one filtration element is made of macroporous material, and
wherein a pore diameter is configured to reduce an amount of partially or fully converted carbide-derived carbon escaping from the reaction chamber.

23. The reactor according to claim 22, wherein the macroporous material comprises a ceramic carbon material.

24. The reactor according to claim 16, wherein the at least one filtration element comprises a first filtration element and a second filtration element that are fluidly connected so as to combine a gas flow from each of the first filtration element and the second filtration element into a single exhaust flow.

25. A method for producing carbide-derived carbon by reacting a halogen gas with a metallic carbide material within a reactor having a reaction chamber, the method comprising:
during the reaction of halogen gas with the carbide material, performing a gas-solid separation by a filtration element of a filter arrangement within a reaction zone of the reaction chamber, and the reaction zone having a temperature above 600° C.

26. The method according to claim 25, wherein the reactor is a fluidized bed reactor and comprises a plenum and a gas distribution plate separating the reaction chamber from the plenum, and
wherein, during operation, the reaction zone is formed adjacent to the gas distribution plate.

27. The method according to claim 26, wherein the reaction chamber has a chamber top and, during operation, a non-reaction zone with temperatures below 600° C. is formed adjacent to the reaction zone, and
wherein the filtration element performs a gas-solid separation within the non-reaction zone and the reaction zone.

28. The method according to claim 26, wherein, during operation, the filtration element engages material fluidized by a gas flowing from the plenum to the reaction chamber.

29. The method according to claim 25, wherein the filtration element performs gas-solid separation with a filtration wall and discharges a filtered gas through a gas channel.

30. The method according to claim 25, wherein the filter arrangement includes a plurality of filtration elements, and the filter arrangement combines a gas flow from each of the filtration elements from the plurality of filtration elements into a single exhaust flow.
